(19) United States
(12) Patent Application Publication
(10) Pub. No.: US 2010/0024468 A1
(43) Pub. Date: Feb. 4, 2010

(54) REFRIGERATION UNIT COMPRISING A MICRO CHANNEL HEAT EXCHANGER

(75) Inventors: Jason Scarcella, Cicero, NY (US); Thomas A. Anderson, Cato, NY (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: CARRIER CORPORATION, Farmington, CT (US)

(21) Appl. No.: 12/445,442

(22) PCT Filed: Oct. 13, 2006
(86) PCT No.: PCT/US06/40128

§ 371 Date: Apr. 13, 2009

(51) Int. Cl. F25B 1/00; B44C 1/22

(52) U.S. Cl. 62/498; 216/37

(57) ABSTRACT

The present disclosure provides a refrigeration unit that can be used in a transport cooling application. The unit comprises a micro-channel heat exchanger (MCHX), a compressor, an evaporator, and a thermostatic expansion valve. The MCHX is coated with an acrylic composition.

### BACKGROUND OF THE INVENTION

1. Field of the Invention

The present disclosure relates to the field of micro-channel heat exchanger technology. More specifically, the present disclosure relates to a micro-channel heat exchanger for use in a container refrigeration application.

2. Description of the Related Art

Refrigerated shipping containers configured to transport refrigerated goods by rail, road, and ship are becoming common place. Prior art refrigerated shipping containers include the shipping container itself and a refrigeration unit secured to one end of the container. Typically, the refrigeration unit is secured to the end of the container opposite the container doors.

Such refrigerated shipping containers are configured to be easily transported on ships, by stacking a number of such containers on top of one another and by placing a number of such stacks of containers in rows and columns next to one another on the ship. After transport by ship, these same containers can be moved by crane and mounted onto a rail car for transport via rail and/or onto a tractor-trailer from transport via road. As such, shipping containers are exposed to various environmental conditions and shipping stresses that can deteriorate the container over time.

Prior art refrigeration units have included standard round tube plate fin (RTPF) heat exchangers that can be used as condensers or evaporators. In RTPF heat exchangers, copper tubes are bonded to copper fins. The tubes are fit through the fin stock, and a mandrel is forced through the tube. This expands the tube, and it interferes with the holes in the fin stock to establish a press fit connection. High thermal efficiency is achieved through direct metallic contact between the tube and fin. Sometimes fin enhancements are utilized to improve the fin's air-side heat transfer capabilities. As a result, great thermal performance is achieved with this high-efficiency coil design.

The large size and weight of the refrigeration unit, as a result of the size and weight of the RTPF heat exchangers, has limited the number of containers that can be placed on the ship, rail, and/or over the road vehicle. Furthermore, RTPF heat exchangers can be extremely expensive due to the high cost of the copper materials. Still further, the volume of such RTPF heat exchangers results in an increased need for costly and environmentally hazardous refrigerants.

Accordingly, it has been determined that there is a need for refrigeration units for shipping containers that overcome, alleviate, and/or mitigate one or more of the aforementioned and other deleterious effects of prior art refrigerated shipping containers.

### SUMMARY OF THE INVENTION

A refrigeration unit which comprises a micro-channel heat exchanger (MCHX) condenser. The MCHX condenser comprises two manifolds, a plurality of flat tubes, and a plurality of fins, wherein said manifolds, flat tubes, and fins are made of aluminum and are coated with an acrylic composition. The MCHX condenser is used in conjunction with a compressor, an evaporator, and a thermostatic expansion valve, and disposed within an enclosure.

### BRIEF DESCRIPTION OF THE DRAWINGS

FIG. 1 is a first perspective view of an exemplary embodiment of the refrigeration unit of the present disclosure;

FIG. 2 is a second perspective view of the refrigeration unit of the present disclosure;

FIG. 3 is a third perspective view of the refrigeration units of the present disclosure;

FIG. 4 is a top view of the heat exchanger coil of the present disclosure;

FIG. 5 is a top view of the heat exchanger coil of the present disclosure, showing the fins disposed between the tubes of the coil; and

FIG. 6 is a front view of the heat exchanger coil of the present disclosure and a system charge holding area.

### DETAILED DESCRIPTION OF THE INVENTION

It has been determined by the present disclosure that a solution to address the above described problems with standard container refrigeration applications includes the use of an MCHX condenser. In contrast to standard RTPF condensers, MCHX condensers are constructed utilizing an all aluminum brazed fin construction. Advantageously, the MCHX condenser of the present disclosure is coated with an acrylic composition that allows for the use of the MCHX condenser in the harsh environments of transport applications. This MCHX condenser provides a significant reduction in the cost, amount of refrigerant used, weight of the coil, and volume of the coil over conventional systems.

An MCHX condenser includes flat micro-channel tubes, fins located between alternating layers of the micro-channel tubes, and two refrigerant manifolds. The manifolds, micro-channel tubes, and fins are joined together into a single condenser using, for example, a nitrogen-charged brazing furnace.

The tube of the MCHX condenser is essentially flat, with its interior sectioned into a series of multiple, parallel flow, micro-channels that contain the refrigerant. In between the flat micro-channel tubes are fins that have been optimized to increase heat transfer. The flat micro-channel tubes are layered in parallel and connected to two refrigerant distribution manifolds. The MCHX condenser can be either single or multiple pass. In some systems, for example, the coil designs may have three or four passes, provided that the system can tolerate the pressure drop in refrigerant through the coil.

The benefits of the MCHX condenser can include improved heat transfer and thermal performance, increased condenser and overall unit efficiencies, substantial refrigerant charge reduction, more compact and reduced condenser sizes, substantial weight reduction, and significant reductions in cost.

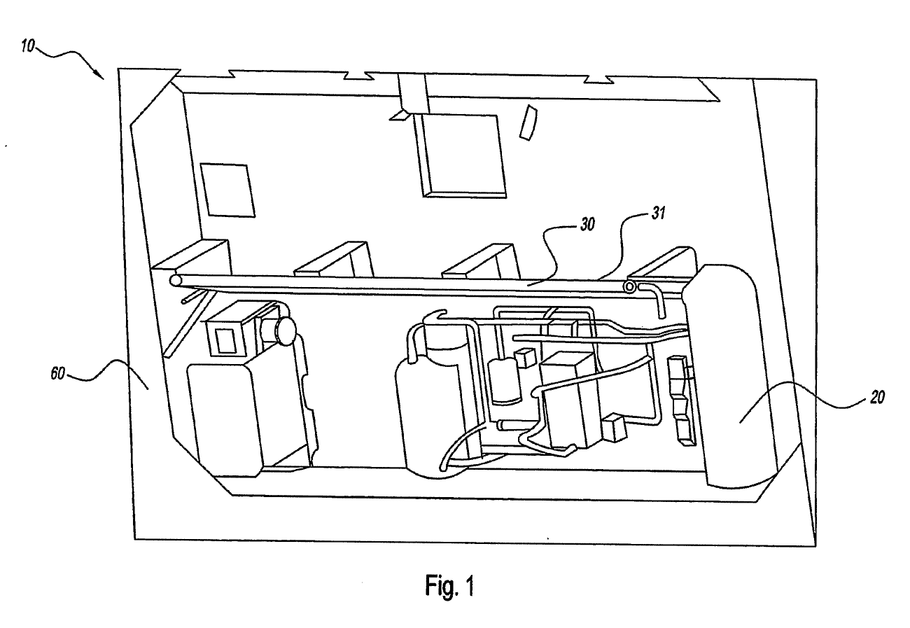

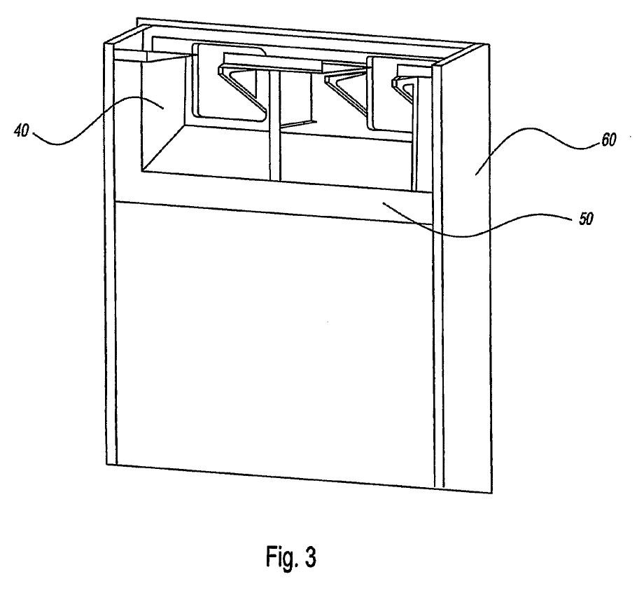

Referring to FIGS. 1-3, a perspective view of a refrigeration unit 10 of the present disclosure is shown. Refrigeration unit 10 has compressor 20, condenser 30, thermostatic expansion valve (TXV) 40, and evaporator 50. Condenser 30 is an MCHX, and is discussed in further detail below. A system charge (not shown) can run through refrigeration unit 10 to perform the cooling operation. Any system charge suitable for use in refrigeration unit 10 can be used. In one embodiment, the system charge can be HFC-134a, manufactured by Dupont.

Compressor 20, condenser 30, TXV 40, and evaporator 50 are all operably connected to each other, such as with pipes or tubes. Refrigeration unit 10 can thus operate in a manner known to those skilled in the art. For example, compressor 20 can compress the system charge, which then flows through condenser 30. While disposed within condenser 30, the system charge can be cooled by interaction with the outside air, and by a condenser fan (not shown). The cooled system charge can then undergo expansion through TXV 40, and enter evaporator 50. The ambient air within the container is thus cooled by interaction with evaporator 50. Condenser 30 is preferably a single pass MCHX condenser, but as previously discussed, in another embodiment condenser 30 can be a multiple pass MCHX condenser.

Refrigeration unit 10 can be connected to an enclosure 50 that is in turn connected to the side of a container or storage device used for shipping. When on a shipping vessel, the refrigeration unit can draw power from a source on the vessel. For over-land applications, an external power source, such as a “clip-on” generator for rail transport, or an “undermount” generator for vehicle transport, can be used. Such power sources are well known to those in the art.

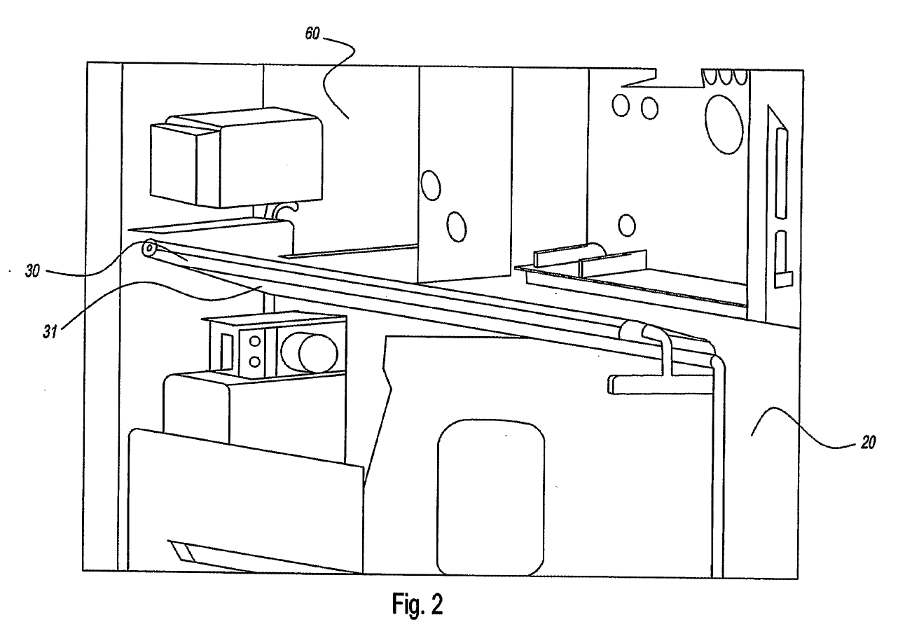

Condenser 30 can be mounted at any angle with respect to enclosure 50, from zero to ninety degrees. A preferred angle of mounting, however, is twenty degrees, as is shown in FIGS. 1 and 2. This has been determined by the present disclosure to be an ideal angle to increase the heat transfer surface area, and optimize air circulation through refrigeration unit 10.

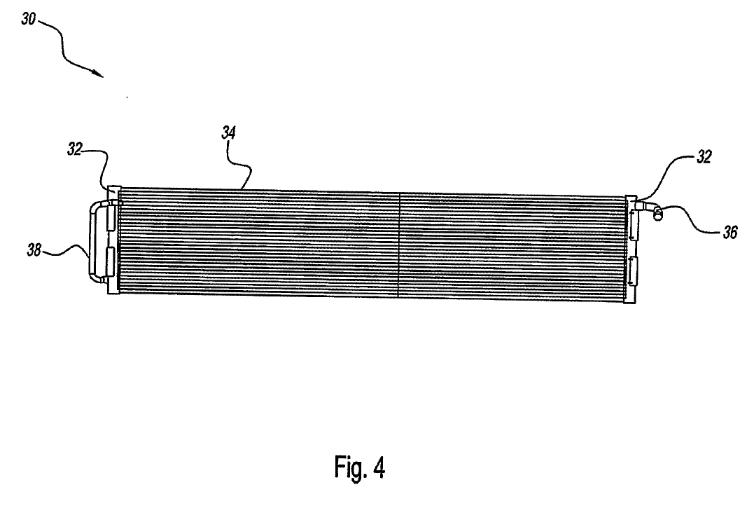

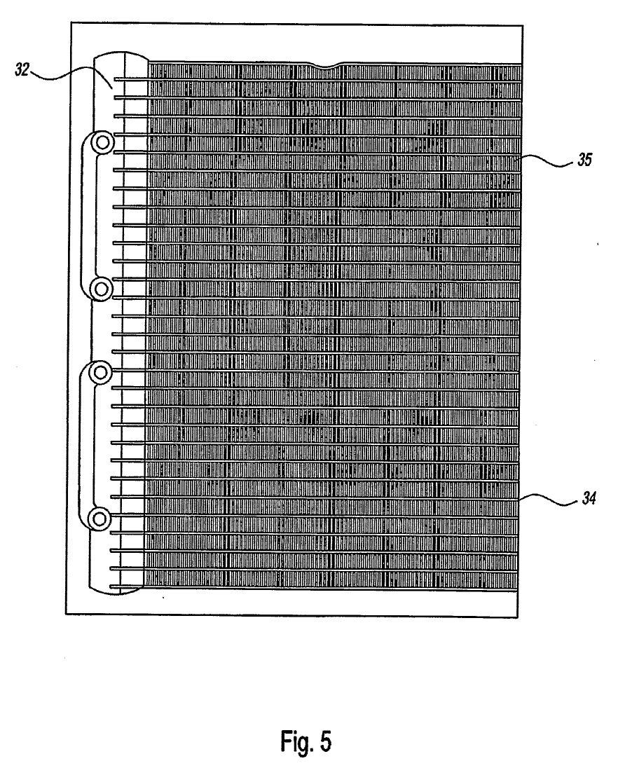

Referring to FIGS. 4 and 5, a more detailed view of condenser 30 is shown. Condenser 30 has a pair of manifolds 32, and a plurality of flat tubes 34. Each flat tube 34 has a plurality of micro-channels (not shown) disposed within, and a plurality of fins 35 connected to the tubes 34. Condenser 30 also has inlet pipe 36 and outlet pipe 38. Thus, during operation of refrigeration unit 10, system charge flows into inlet pipe 36, through a first manifold 32, through the flat tubes 34 and the micro-channels disposed therein, into a second manifold 32, and out of outlet pipe 38. The system charge within condenser 30 is cooled by interaction with the ambient air surrounding condenser 30.

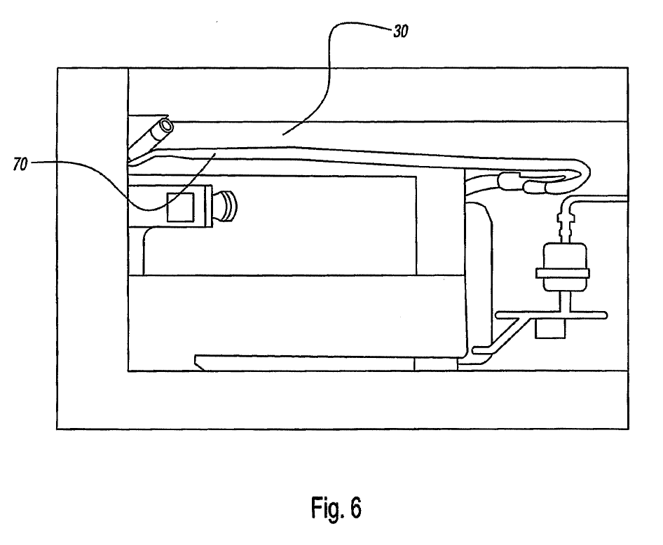

Referring to FIG. 6, the condenser 30 can also be connected to a sealed system charge holding area 70. This system charge holding area is the subject of a separate co-pending application entitled “Refrigeration Circuit,” filed on Oct. 13, 2006, and having attorney docket No. 0002832WOU, the contents of which are herein incorporated by reference in its entirety.

In order to withstand the harsh conditions of the marine environment, the condenser 30 of the present disclosure must be coated with an appropriate protective material. The materials that comprise condenser 30 are preferably pretreated to remove any residual aluminum oxide layers disposed on the surface of the material. Methods to remove oxidation are well known to those in the art. For example, in one method, flux can be electrostatically applied to the aluminum to remove aluminum oxide layers and allow a clad material already applied to the tubes to flow in clean joint areas for sound metallurgical joints. Condenser 30 is then etched. This etching is a process well known in the art, and attempts to remove any oxide that may have formed before chromatting. For example, condenser 30 can be etched with a chemical composition that comprises hydrogen fluoride.

The MCHX condenser 30 is then chromatted by immersion in a chrome phosphate solution. Excess chrome is removed with a deionizing water rinse. The MCHX condenser 30 is then coated with a layer of an acrylic solution 31, using an e-coating process. During this process, condenser 30 is electrostatically charged and dipped in an acrylic solution, which has been charged to the opposite polarity of the condenser. Charging voltage and immersion time can determine the coating thickness. Excess solution is blown free with air before curing. A coating thickness of 50 microns max is desired. The preferred acrylic composition is a dual component composition comprising Resin CR830 and CP504 Paste, sold by PPG Industries, Inc.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

1. A refrigeration unit, comprising:
a compressor;
a micro-channel heat exchanger condenser, wherein said heat exchanger condenser comprises two manifolds, a plurality of flat tubes, and a plurality of fins, wherein said manifolds, flat tubes, and fins are aluminum, and have a coating comprising an acrylic composition;
a thermostatic expansion valve,
an evaporator; and
an enclosure, wherein said heat exchanger coil, said evaporator, and said compressor are disposed within an enclosure.

2. The refrigeration unit of claim 1, wherein said coating has a thickness of 50 microns or less.

3. The refrigeration unit of claim 1, further comprising a chrome phosphate coating disposed beneath said acrylic composition coating.

4. The refrigeration unit of claim 1, wherein said heat exchanger coil is mounted to said enclosure at an angle of twenty degrees.

5. The refrigeration unit of claim 1, further comprising a system charge holding area operably connected to said heat exchanger coil.

6. A method of coating a micro-channel heat exchanger, comprising:
electrostatically applying flux to a surface of said heat exchanger;
etching said surface of said heat exchanger;
immersing said heat exchanger in a chrome phosphate solution; and
electrostatically charging said heat exchanger and immersing said heat exchanger in an acrylic solution, wherein said acrylic solution has been charged to the opposite polarity of said heat exchanger.
